(19) United States
(12) Patent Application Publication
(10) Pub. No.: US 2024/0221310 A1
(43) Pub. Date: Jul. 4, 2024

(54) MAPPING WILDFIRE SPREAD PROBABILITY TO REGIONS OF INTEREST

(71) Applicant: X Development LLC, Mountain View, CA (US)

(72) Inventors: Akshina Gupta, Warren, NJ (US); Nisarg Ghanyshambhai Vyas, Gujarat (IN); Krishna Kumar Rao, Stanford, CA (US); Rushabh Nikhilkumar Solanki, Gujarat (IN); Shivani Jayantkumar Upadhyay, Gujarat (IN)

(21) Appl. No.: 18/397,018

(22) Filed: Dec. 27, 2023

Related U.S. Application Data
(60) Provisional application No. 63/436,431, filed on Dec. 30, 2022.

(51) Int. Cl. G06T 17/05; G06V 10/75

(52) U.S. Cl. CPC G06T 17/05; G06V 10/759

(57) ABSTRACT

Methods, systems, and apparatus for receiving, by a wildfire modeling system, region of interest (ROI) data representative of pixels that represent a geographical ROI, generating, by the wildfire modeling system, transition probabilities for each pixel in the ROI data, determining, by the wildfire modeling system, chained probabilities along each path in a set of paths within the ROI, adjusting, by the wildfire modeling system, chained probabilities based on a likelihood of ignition of a starting pixel represented in the ROI data, combining, by the fire modeling system, the adjusted chained probabilities to provide connectivity data that represents respective likelihood of spread of a wildfire from the starting pixel to each other pixel within the ROI, and displaying a connectivity map that graphically represents connectivity data of each pixel within the ROI.

### CROSS-REFERENCE TO RELATED APPLICATION

This application claims priority under 35 U.S.C. 119 to Provisional Application No. 63/436,431, filed Dec. 30, 2022, which is incorporated by reference.

### TECHNICAL FIELD

This specification relates generally to using machine learning to predict wildfire spread within regions of interest.

### BACKGROUND

Natural disasters are increasing in both frequency and intensity. Example natural disasters can include wildfires, hurricanes, tornados, and floods, among several others. Natural disasters often result in significant loss that can include a spectrum of economic losses, property losses, and physical losses (e.g., deaths, injuries). Consequently, significant time and effort is expended not only predicting occurrences of natural disasters, but characteristics of natural disasters such as duration, severity, spread, and the like. Technologies, such as artificial intelligence (AI) and machine learning (ML), have been leveraged to generate predictions around natural disasters. However, natural disasters present a special use case for predictions using ML models, which results in technical problems that must be addressed to generate reliable, accurate, and actionable predictions.

### SUMMARY

This specification describes systems, methods, devices, and other techniques relating to utilizing machine learning (ML) to gain insights about wildfire spread. More particularly, implementations of the present disclosure are directed to a ML system for mapping wildfire spread probability within regions-of-interest (ROIs).

In general, innovative aspects of the subject matter described in this specification can include actions of receiving, by a wildfire modeling system, region of interest (ROI) data representative of pixels that represent a geographical ROI, generating, by the wildfire modeling system, transition probabilities for each pixel in the ROI data, determining, by the wildfire modeling system, chained probabilities along each path in a set of paths within the ROI, adjusting, by the wildfire modeling system, chained probabilities based on a likelihood of ignition of a starting pixel represented in the ROI data, combining, by the fire modeling system, the adjusted chained probabilities to provide connectivity data that represents respective likelihood of spread of a wildfire from the starting pixel to each other pixel within the ROI, and displaying a connectivity map that graphically represents connectivity data of each pixel within the ROI. Other implementations of this aspect include corresponding systems, apparatus, and computer programs, configured to perform the actions of the methods, encoded on computer storage devices.

These and other implementations can each optionally include one or more of the following features: each transition probability is generated by a machine learning (ML) model that receives at least a portion of the ROI data as input and provides transition probabilities for respective pixels represented in the at least a portion of the ROI data as output; the ML model is a gradient boosted decision trees model; the ML model is trained using training data representative of one or more of data types including existing vegetation cover, existing vegetation type, existing vegetation type, digital elevation model, canopy cover, canopy bulk density, population density, land cover type, imperviousness, roads, precipitation, minimum relative humidity, fuel moisture over a configured period, maximum temperature, enhanced vegetation index, normalized difference vegetation index (NDVI), normalized difference water index, mean wind speed, wind speed variance, and wind rose directions; and the chained probabilities are determined using one of a sum over paths and a union over paths.

The present disclosure also provides a non-transitory computer-readable storage medium coupled to one or more processors and having instructions stored thereon which, when executed by the one or more processors, cause the one or more processors to perform operations in accordance with implementations provided herein.

It is appreciated that the methods and systems in accordance with the present disclosure can include any combination of the aspects and features described herein. That is, methods and systems in accordance with the present disclosure are not limited to the combinations of aspects and features specifically described herein, but also include any combination of the aspects and features provided.

Particular implementations of the subject matter described in this specification can be implemented so as to realize one or more of the following advantages. The representation of the connectivity of pixels, as described in this specification, represents a tendency of wildfire spread instead of representing each spread metric individually. This enables the probability of wildfire spread to be determined more accurately. Further, the connectivity of a pixel is defined for ignitions within a certain distance rather than for ignitions at a particular distance, providing more accurate risk determination. The connectivity of a pixel to other pixels that are within a predefined distance kernel can be defined using all possible wildfire traversing paths or using a subset of paths, allowing the system to perform computations with increased accuracy, and more efficient use of computing resources.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example connectivity map.

FIG. 2 depicts an example machine learning (ML) system in accordance with implementations of the present disclosure.

FIGS. 3-5 depict example representations of pixels and respective values to illustrate generation of connectivity data in accordance with implementations of the present disclosure.

FIG. 6 depicts example graphical representations of an ignition map and connectivity maps in accordance with implementations of the present disclosure.

FIG. 7 is a flow diagram of an example process in accordance with implementations of the present disclosure.

Like reference numbers and designations in the various drawings indicate like elements.

### DETAILED DESCRIPTION

The technology of this patent application is directed to use of machine learning (ML) in predicting wildfire spread. More particularly, implementations of the present disclosure are directed to a ML system for mapping wildfire spread probability within regions-of-interest (ROIs).

Implementations of the present disclosure are described in further detail herein with reference to an example natural disaster, which includes wildfires. It is contemplated, however, that implementations of the present disclosure are applicable to any appropriate natural disaster, such as natural disasters that include periods of spatial progression.

To provide context for the subject matter of the present disclosure, and as introduced above, artificial intelligence (AI) and ML have been leveraged to generate predictions around natural disasters. For example, ML models can be used to generate predictions representative of characteristics of a natural disaster, such as likelihood of occurrence, duration, severity, spread, among other characteristics, of the natural disaster.

In further detail, one or more ML models can be trained to predict characteristics of a natural disaster using training data that is representative of characteristics of occurrences of the natural disaster, for example. The training data can include region data representative of respective regions (e.g., geographical areas), at which the natural disaster has occurred. In some examples, each ML model predicts a respective characteristic of the natural disaster. Example ML models can include, without limitation, a risk model that predicts a likelihood of occurrence of the natural disaster in a region, a spread model that predicts a rate of spread of the natural disaster in the region, a spread model that predicts a spread of the natural disaster in the region, and an intensity model that predicts an intensity of the natural disaster. Characteristics of a natural disaster can be temporal. For example, a risk of wildfire is higher in a dry season than in a rainy season. Consequently, each ML model can be temporal. That is, for example, each ML model can be trained using training data representative of regions at a particular period of time.

In further detail, the region data can include an image of the region and a set of properties of the region. More generally, the region data can be described as a set of data layers (e.g., N data layers), each data layer providing a respective type of data representative of a property of the region. In some examples, each data layer includes an array of pixels, each pixel representing a portion of the region and having data associated therewith that is representative of the portion of the region. A pixel can represent an area (e.g., square meters (m²), square kilometers (km²)) within the region. The area that a pixel represents in one data layer can be different from the area that a pixel represents in another data layer. For example, each pixel within a first data layer can represent X km² and each pixel within a second data layer can represent Y km², where X≠Y.

An example, data layer can include an image layer, in which each pixel is associated with image data, such as red, green, blue (RGB) values (e.g., each ranging from 0 to 255). Another example layer can include a vegetation layer, in which, for each pixel, a normalized vegetation difference index (NVDI) value (e.g., in range of [−1, 1]). Other example layers can include, without limitation, a temperature layer, in which a temperature value is assigned to each pixel, a humidity layer, in which a humidity value is assigned to each pixel, a wind layer, in which wind-related values (e.g., speed, direction) are assigned to each pixel, a barometric pressure layer, in which a barometric pressure value is assigned to each pixel, a precipitation layer, in which a precipitation value is assigned to each pixel, and an elevation layer, in which an elevation value is assigned to each pixel.

Because values across the data layers can change over time, the region data can be temporal. For example, temperature values for the region can be significantly different in summer as compared to winter.

Accordingly, the region data can include an array of pixels (e.g., [p_{1,1}, . . . , p_{i,j}]), in which each pixel is associated with a vector of N dimensions, N being the number of data layers. For example, p_{i,j}=[I_{i,j}, V_{i,j}, W_{i,j}, . . . ], where I is image data, V is vegetation data, and W is weather data.

As training data, the region data, which can be referred to as region training data, can include one or more characteristic layers that provides known characteristic data for respective characteristics of a natural disaster. The known characteristic data represents actual values of the respective characteristics as a result of the natural disaster. For example, a wildfire can occur within a region and, as a result, characteristics of intensity, spread, duration, and the like can be determined for the wildfire. Accordingly, as training data, the region data can include, for example, p_{i,j}=[I_{i,j}, V_{i,j}, W_{i,j}, . . . , C_{A,i,j}^{K}, C_{B,i,j}^{K}, . . . ], where C_{A,i,j}^{K} and C_{A,i,j}^{K} are respective known (K) characteristics of a natural disaster in question.

One or more ML models are trained using the region training data. The training process can depend on a type of the ML model. In general, the ML model is iteratively trained, where, during an iteration, also referred to as epoch, one or more parameters of the ML model are adjusted, and an output (e.g., characteristic value) is generated based on the training data. For each iteration, a loss value is determined based on a loss function. The loss value represents a degree of accuracy of the output of the ML model as compared to a known value (e.g., known (ground truth) characteristic). The loss value can be described as a representation of a degree of difference between the output of the ML model and an expected output of the ML model (the expected output being provided from training data). In some examples, if the loss value does not meet an expected value (e.g., is not equal to zero), parameters of the ML model are adjusted in another iteration (epoch) of training. In some examples, the iterative training continues for a pre-defined number of iterations (epochs). In some examples, the iterative training continues until the loss value meets the expected value or is within a threshold range of the expected value.

To generate predictions, region data representative of a region, for which predictions are to be generated, is provided as input to a (trained) ML model, which generates a predicted characteristic for each pixel within the region data. An example output of the ML model can include p_{i,j}=[C_{i,j}^{P}], where C is a characteristic predicted (P) by the ML model. Example characteristics can include, without limitation, likelihood of occurrence (e.g., risk), a rate of spread, an intensity, and a duration. In some examples, an image of the region can be displayed to visually depict the predicted characteristic across the region. For example, different values of the characteristic can be associated with respective visual cues (e.g., colors, shades of colors), and the predicted characteristic can be visually displayed as a heatmap over an image of the region.

While ML models are useful in generating predictions, natural disasters present a special use case for predictions using ML models. More particularly, various technical problems arise that must be addressed to generate reliable, accurate, and actionable predictions. For example, a likelihood of spread of a wildfire to a location can depend on the environmental conditions not only at that location, but also at other locations, at which a wildfire could ignite and subsequently spread to the location. For example, regions that are downwind from regions that are susceptible to wildfires are also often susceptible to wildfires. More generally, the direction and rate of spread of a wildfire depends on numerous factors including, without limitation, topography, wind speed, wind direction, type of vegetation, moisture in vegetation, land cover, meteorological factors, and the like.

Wildfire spread is also dependent on available paths, along which the wildfire could spread. The number of paths can be relatively large, increasing exponentially as the size of the ROI increases. This presents challenges in the ML context, as complex ML models would need be developed to account for the numerosity of possible paths, and/or a significantly large number of computations can be required to generate predictions. Developing complex ML models is a technical challenge in its own right, but also results in technical challenges in obtaining appropriate training data, inefficiencies in the training process, and accuracy, among other challenges. Increasing numbers of computations not only increases the time required to generate the predictions, but also consumes significant technical resources (e.g., processors, memory).

In view of the foregoing, implementations of the present disclosure are directed to a ML system for resource-efficient mapping of wildfire spread probability within ROIs. More particularly, implementations of the present disclosure provide a resource-efficient framework for improved accuracy of predicting wildfire spread within ROIs. Spread can also be referred to herein as transition (e.g., a wildfire transitioning from one pixel to another pixel). As described in further detail herein, the ML system of the present disclosure aggregates metrics related to wildfire spread into a single index. The index can quantify the likelihood that a wildfire igniting at one location will spread to another location that is within a predefined distance kernel. Each location is a geographic region represented as a pixel, introduced above. Here, C_{i,j}^{P} can be the likelihood of spread to the location represented by pixel i,j. In some examples, the distance kernel is provided as a square having sides of a determined distance (e.g., a square with 250 km sides). It is appreciated, however, that the distance kernel can be of any appropriate shape. Here, the distance kernel can define the bounds of the ROI.

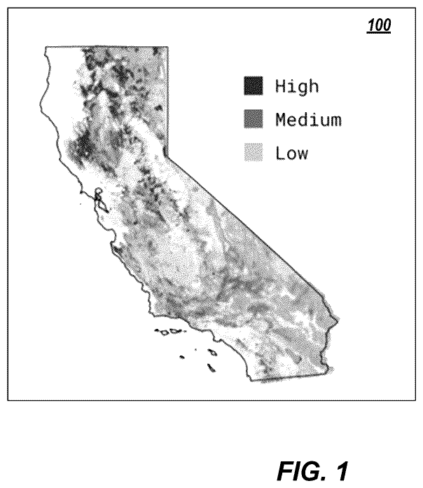

Implementations of the present disclosure also provide connectivity maps, which graphically depict the likelihood of a wildfire to spread to a pixel (location), if a wildfire were to ignite in another pixel. FIG. 1 depicts an example connectivity map 100. In the example of FIG. 1, the connectivity map 100 represents the state of California for the year 2016, where each pixel represents an area that is 500 m×500 m (250,000 m² or 0.25 km²). Darker shades indicate pixels that have stronger connections to their surrounding pixels, and lighter shades indicate pixels that have weaker connections to their surrounding pixels. That is, if a wildfire were to ignite at one pixel, the wildfire is more likely to spread to darker shaded pixels than lighter shaded pixels.

As described herein, the connectivity map of the present disclosure provides a representation of connectivity of pixels based on tendency of wildfire spread instead of representing each driver individually. Further, the connectivity data underlying the connectivity map is robust to varying distances between ignitions and pixels of interest. For example, connectivity of a pixel is defined for ignitions within a certain distance (kernel distance), not for ignitions at a particular distance from the pixel. This distance is pre-defined and can vary based on user input. Further, and as described herein, connectivity of a pixel to all other pixels within a predefined distance kernel is defined using all possible wildfire traversing paths, or through a subset of paths. In some implementations, intelligent caching to avoid duplication of estimation of pixel-to-pixel wildfire transition probabilities.

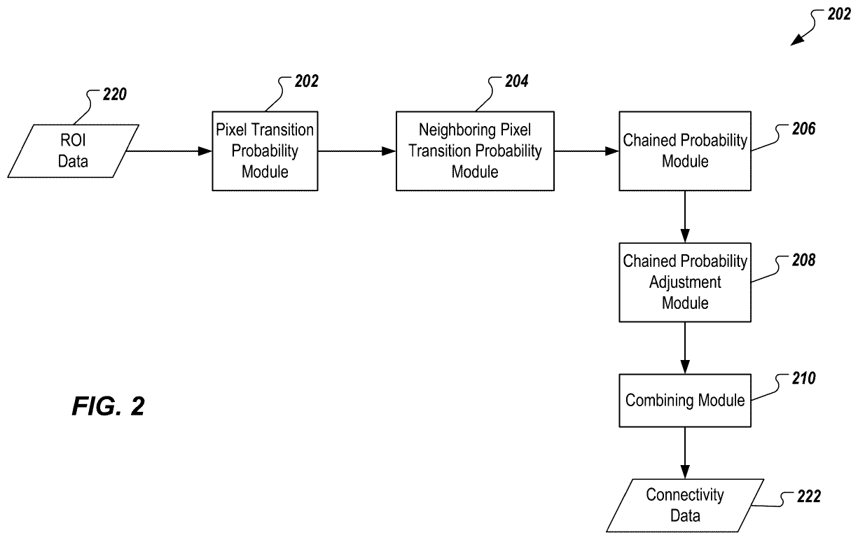

FIG. 2 depicts an example ML system 200 in accordance with implementations of the present disclosure. In the example of FIG. 2, the ML system 200 includes a transition probability module 202, a neighboring pixel transition probability module 204, a chained probability module 206, a chained probability adjustment module 208, and a combining module 210. In some examples, each of the modules of the ML system 200 can be provided as one or more computer-executable programs executed by one or more computing devices. As described in further detail herein, the ML system 200 processes ROI data 220 to provide connectivity data 222.

The ROI data 220 includes data representative of the ROI provided as an array of pixels (e.g., [p_{1,1}, . . . , p_{i,j}]), in which each pixel is associated with a vector of N dimensions, N being the number of data layers. In some examples, the ROI data 220 can be determined based on an identification of a ROI within a larger region. For example, and without limitation, a user can identify the ROI within a larger region and ROI data for the ROI can be retrieved (e.g., from a database) to populate the ROI data 220. In some examples, the user can overlay an ROI boundary on a map (e.g., an ignition map) and data representative of pixels within the ROI boundary can be retrieved to populate the ROI data 220. The connectivity data 222 indicates, for each pixel within the ROI, a likelihood of a wildfire spreading to the pixel. The connectivity data 222 can be graphically depicted in a connectivity map (e.g., the connectivity map 100 of FIG. 1).

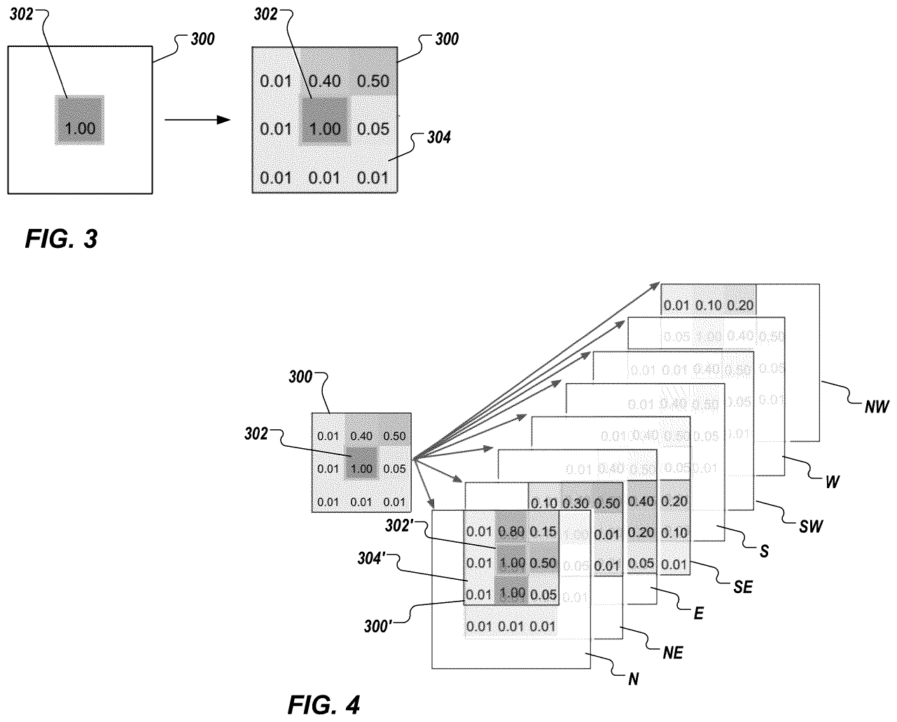

FIGS. 3-5 depict example representations of pixels and respective values to illustrate generation of connectivity data in accordance with implementations of the present disclosure. In discussing FIGS. 3-5, compass directions are referenced, in which north (N) is toward the top of the drawing sheet, east (E) is toward the right of the drawing sheet, south (S) is toward the bottom of the drawing sheet, and west (W) is toward the left of the drawing sheet. As described in further detail herein, connectivity data is generated by (i) determining pixel transition probabilities; (ii) determining neighboring pixel transition probabilities, (iii) determining chained probabilities along paths between pixels; (iv) adjusting chained probabilities for likelihood of ignition; and (v) combining the adjusted chained probability maps.

With regard to determining pixel transition probabilities, the ML system of the present disclosure (e.g., the transition probability module 202 of FIG. 2) determines the probability that a wildfire will spread in each of a set of primary directions (e.g., N, E, W, S) and a set of intermediate directions (e.g., NE, NW, SE, SW) from a starting pixel in a ROI. In some examples, the starting pixel within the ROI can be a pixel that is at the center, or within a threshold distance of the center of the ROI. In some examples, the starting pixel is selected as a pixel having a highest likelihood of wildfire ignition within the ROI. For example, the ROI (or a region within which the ROI is located) can be processed through a ML model that predicts likelihood of wildfire ignition for each pixel, which can be used to determine a starting pixel.

FIG. 3 depicts an example sub-region, defined within a frame 300, within a ROI, the sub-region including a set of pixels. The set of pixels includes a center pixel 302 (e.g., a starting pixel) and neighboring pixels 304, that are immediate neighbors of the center pixel 302. The center pixel 302 is representative of a pixel, in which a wildfire is deemed to have ignited. That is, the center pixel 302 can be determined to be the starting pixel within the ROI. Consequently, the center pixel 302 includes a transition probability of 1.00 indicating that a wildfire is deemed to have ignited in the center pixel 300. Data representative of the neighboring pixels 304 is processed to determine a transition probability for each neighboring pixel 304. In the example of FIG. 3, values in each of the adjacent pixels 304 represent a respective transition probability generated for the respective neighboring pixel 304. The transition probability at a neighboring pixel 304 indicates the probability that the wildfire of the center pixel 302 will spread to the neighboring pixel 304.

In some implementations, each of the transition probabilities is provided as a prediction output by a ML model. For example, the pixel transition probability module 202 can execute a ML model that receives the ROI data 220 as input and, for each neighboring pixel of a center pixel, predicts a transition probability. An example ML model can include, but is not limited to, a gradient boosted decision tree model, such as the Light Gradient Boosting Machine (LightGBM). In general, gradient boosting produces a predictive ML model in the form of an ensemble of weak prediction models, which can be decision trees. In some examples, the model begins with a weak learner—that is, a ML model where the difference between predicted values and observed (ground truth) values exceed a threshold—and iteratively adds weak learners to the ML model, reducing loss (i.e., the difference between predicted values and observed (ground truth) values) at each iteration. The result of the ensemble generation process is a strong learner—that is, a ML model that generates predictions with an accuracy that meets or exceeds a threshold accuracy.

The ML model is trained using training data. In the context of the present disclosure, training data can be obtained from data provided by satellites that record burn information for individual pixels within regions. Burned pixels from successive time periods can be paired to record changes in wildfire states as a wildfire progresses. The duration between measurements can be configured with a default value (e.g., 1 day to see how the wildfire progresses from day-to-day). In some examples, each pixel in the training data can be labeled with a 1 to indicate that the area represented by the pixel burned, or a 0 to indicate the area represented by the pixel is unburned.

In some examples, training features can be determined from the training data by creating a flattened vector of the training features that relate to a center pixel. The flattened vector can be used to estimate the transition probabilities of neighboring pixels. Example training features (e.g., data layers) can include, but are not limited to, existing vegetation cover, existing vegetation type, elevation, canopy cover, canopy bulk density, population density, land cover type, whether the region is impervious, roads, precipitation, minimum relative humidity, fuel moisture over a configured period (e.g., 100 hours), maximum temperature, enhanced vegetation index, NDVI, normalized difference water index, mean wind speed, wind speed variance, and wind rose directions. It is contemplated that any appropriate training features for pixels can be used.

In accordance with implementations of the present disclosure, transition probabilities are determined for each pixel across the distance kernel (i.e., the ROI). In some examples, the neighboring pixel transition probability module 204 determines transition probabilities for the neighboring pixels. To achieve this, the frame 300 is incrementally shifted and, for each increment, transition probabilities are determined. In some examples, for each neighboring pixel of the center pixel, after a shift, the neighboring pixel can be considered as a center pixel and transition probabilities are determined for its neighboring pixels. In some examples, transition probabilities are determined for neighboring pixels that have not yet been determined to have had a wildfire ignite therein (i.e., neighboring pixels that already have a transition probability of 1.00).

In some examples, the neighboring pixel transition probability module 204 determines transition probabilities using the same ML model as the pixel transition probability module 202. In some examples, the pixel transition probability module 202 and the neighboring pixel transition probability module 204 can be provided as a single module that uses the ML model to predict pixel transition probabilities and neighboring pixel transition probabilities as described herein.

Determining transition probabilities with shifting the frame 300 within the ROI is depicted in FIG. 4. As represented in FIG. 4, the frame 300 is shifted by one pixel in each direction to provide a set of shift frames 300′, each shift frame 300′ corresponding to a respective direction. For example, and as depicted in FIG. 4, the shift frames 300′ include N, NE, E, SE, S, SW, W, NW. With reference to the N shift frame 300′, the center pixel 302 of FIG. 3 is a neighboring pixel 304′ in FIG. 4 and the neighboring pixel 304 that had been north of the center pixel 302 of FIG. 3 is a center pixel 302′ in FIG. 4. Likewise, and with reference to the NE shift frame, the center pixel 302 of FIG. 3 is a neighboring pixel in FIG. 4 and the neighboring pixel that had been northeast of the center pixel 302 of FIG. 3 is a center pixel in FIG. 4, and so on across the shift frames. Each of the shift frames is processed through the ML model, which outputs transition probabilities for each neighboring pixel, as discussed above. In some examples, if a transition probability of a neighboring pixel had previously been determined to be 1.00, a transition probability is not determined again. For example, in the example of FIG. 4, a transition probability would not be determined for the neighboring pixel 304′ (which had been the center pixel 302 in FIG. 3), because it had previously been assigned a transition probability of 1.00.

The ML system repeats this computation until all pixels within the predefined distance kernel have a transition probability determined. For example, if each pixel represents a square area having 500 m sides, and the distance kernel (i.e., ROI) represents a square area having 250 km sides, and assuming the frame is initially at the center, the frame would shift approximately 250 times to the right (E) with transition probabilities being determined for each shift, the frame would shift approximately 250 times to the left (W) with transition probabilities being determined for each shift, the frame would shift approximately 250 times upward (N) with transition probabilities being determined for each shift, and the frame would shift approximately 250 times to downward (S) with transition probabilities being determined for each shift, not to mention the numerous shifts to account for NE, SE, SW, and NW directions in between.

In some implementations, caching is used to avoid duplication of determining of pixel-to-pixel transition probabilities. In this manner, the number of computations is reduced. In some examples, if a wildfire spread overlaps pixels for which transition probabilities have been computed, the previously computed value can be used. Instead of calculating new transition probabilities. Caching can be performed at various levels of data granularity (e.g., transition probabilities associated with a single property, a small number of adjacent properties, a neighborhood, a community). In some examples, cache entries can be maintained for likely wildfire paths, for example, as determined by common wind direction. That is, for example, transition probabilities for pixels lying in a same, consecutive wind direction can be cached. In some examples, when determining the transition probability for a pixel, likely paths from ignition (starting pixel) to the pixel can be determined, and the cache can be checked to determine whether a probability of the wildfire path existing is above a threshold probability. If so, transition probabilities for pixels along the wildfire path can be retrieved from the cache to avoid re-computation.

In accordance with implementations of the present disclosure, the ML system computes chained probabilities along paths within the region represented by the ROI data. In some examples, chained probabilities along paths can be determined using any appropriate technique. The chained probability module 206 of the ML system 200 of FIG. 2 can determine the chained probabilities.

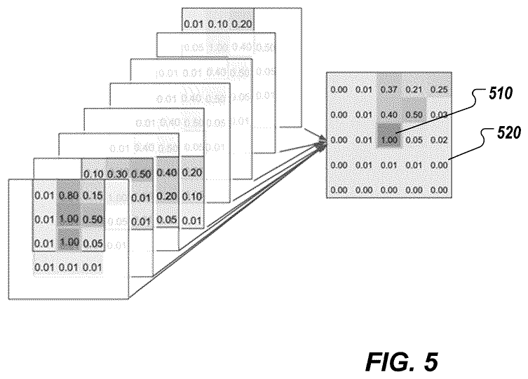

FIG. 5 depicts an example technique to determine chained probabilities. In the example of FIG. 5, chained probabilities can be determined by multiplying the transition probabilities along paths from the original ignition point (e.g., the center pixel 302 of FIG. 3) to respective pixels within the distance kernel. FIG. 5 illustrates a specific case in which an edge pixel 520 is two pixels away from a center pixel 510 (e.g., originally, the center pixel 302 of FIG. 3). However, the chained probabilities are calculated along all paths to the edges of the distance kernel.

In some examples, to compute the chained probabilities along paths, the transition probabilities can be aggregated by a union of all of the transition probabilities along a path. This includes adding up the transition probabilities of each path and subtracting the probability of two paths co-occurring. This is represented in Equation 1 below:

$${CP}_{j} = 1 - {\prod }^{All paths} {\prod }_{i , i + 1}^{Length of paths} ( 1 - {tp}_{1} ) ( 1 - {tp}_{i + 1} ) \qquad ( 1 )$$

i is an index of a pixel along the chosen path from ignition point to pixel j, tp is the transition probability, and CP is the chained probability.

In some examples, to compute the chained probabilities along paths, the transition probabilities along a specific path from ignition point to any pixel within the predefined distance kernel are multiplied and then summed over all possible paths to the pixel.

In some examples, the chained probabilities can be determined by stochastically chaining the transitional probabilities, which can be achieved by sampling from a uniform distribution U(0,1) at each pixel, binarizing the sample based on the inequality between the sample and the pixel's transition probability and computing the mean of all such samples. For example, if two pixels with transition probabilities of 0.6 and 0.8, respectively, are to be chained, the deterministic chaining technique results in a chained probability of 0.6×0.8=0.48. The stochastic chaining technique can sample U(0,1) a configured number of iterations (e.g., 15) for each of the two pixels, set the stochastic transition probability to 1 or 0 based on each pixel's sample being less than its respective transition probability, multiplying the two stochastic transition probabilities, and averaging the result over the samples.

In accordance with implementations of the present disclosure, the ML system adjusts the chained probabilities for the likelihood of ignition. For example, the chained probability adjustment module 208 of the ML system 200 of FIG. 2 adjusts the chained probabilities. In further detail, while the chained probabilities indicate the total likelihood of wildfire spread (because the individual probabilities are multiplied), the chained probabilities are not indicative of the likelihood of ignition of the ignition point (i.e., starting pixel). This result occurs because the transition probabilities are calculated by assigning a transition probability of 1.00 to the ignition point (i.e., the starting pixel), as described herein. Implementations of the present disclosure adjust the chained probabilities to account for this. Various adjustment (weighting) approaches can be used such as ignition-based weighting and feature-based weighting.

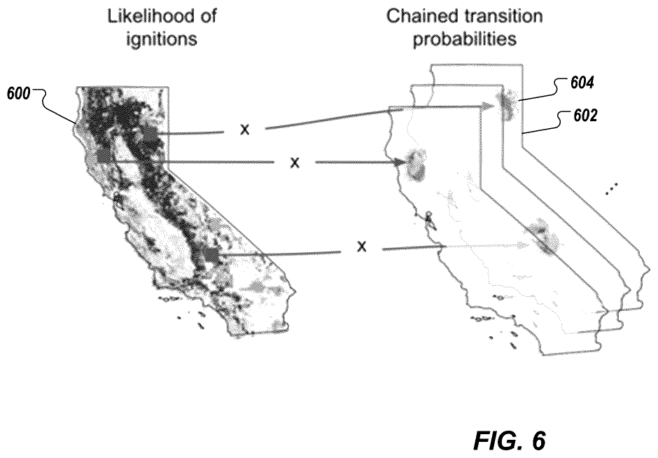

In ignition-based weighting, each chained probability map is adjusted (weighted) by the ignition probability of the respective ignition point from which the map was initiated. For example, and as described herein, a likelihood of wildfire ignition for the starting pixel can be determined using a ML model. The values across the chained probability map can be weighted by (e.g., multiplied by) the likelihood of wildfire ignition of the starting pixel. With reference to FIG. 6, graphical representations of an ignition map 600 and connectivity maps 602, each connectivity map 602 corresponding to a respective ROI 604. In some examples, the ignition map 600 is provided by processing pixel data through a ML model, which determines, for each pixel, a likelihood of wildfire ignition (i.e., a probability that a wildfire will ignite within the sub-region represented by the respective pixel). The likelihood of ignition for the starting pixel of the ROI 604 can be determined from the ignition map 600 and can be used to adjust the chained probabilities for pixels within the ROI 604.

In feature-based weighting, the individual probability maps are weighted using features. For each feature, a respective technique for determining weight can be used. For example, the pixels having lower NDVI values can have lower weights applied there to as compared to the pixels having higher NDVI values. In this example, because NDVI values are continuous, piecewise linear scaling can be used. In cases where features are categorical (e.g., landcover, no landcover), each category can be assigned a different value depending on the category type. The features used when determining weights can include NDVI, landcover type, roads, whether the surface is impervious, and the like.

In some implementations, the adjusted (weighted) chained probability maps are combined (e.g., by the combining module 210 of the ML system 200 of FIG. 2) to produce connectivity data (e.g., the connectivity data 200 of FIG. 2). In some examples, the adjusted chained probability maps can be stacked according to their geolocation and summed to obtain the combined chained probability as connectivity data for each pixel within the ROI. The connectivity data can be graphically represented within a connectivity map, such as the connectivity map 100 of FIG. 1. Because the adjusted chained probabilities are summed (and not the individual transition probabilities), a pixel's value within the connectivity data indicates the likelihood that the corresponding sub-region represented by the pixel will be affected by a wildfire occurring within the ROI (i.e., as defined by the distance kernel).

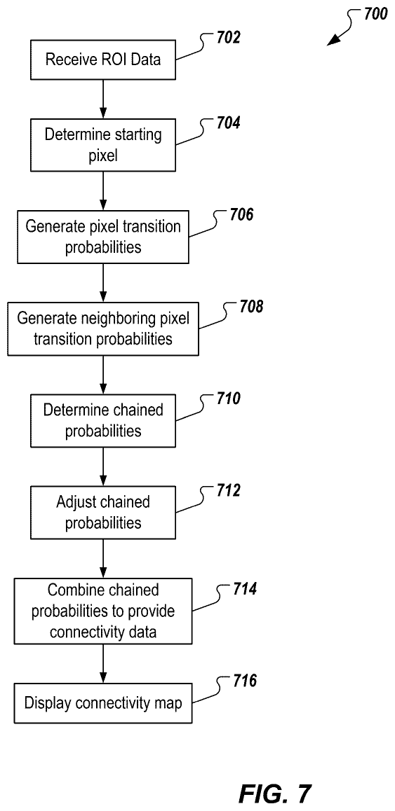

FIG. 7 is a flow diagram of an example process 700 in accordance with implementations of the present disclosure. In some examples, the example process 700 is provided using one or more computer-executable programs executed by one or more computing devices.

ROI data is received (702). For example, and as described herein, the ROI data 220 of FIG. 2 can be determined based on an identification of a ROI within a larger region. For example, and without limitation, a user can identify the ROI within a larger region and ROI data for the ROI can be retrieved (e.g., from a database) to populate the ROI data 220. In some examples, the user can overlay an ROI boundary on a map (e.g., an ignition map) and data representative of pixels within the ROI boundary can be retrieved to populate the ROI data 220. A starting pixel is determined (704). For example, and as described herein, the starting pixel within the ROI can be a pixel that is at the center, or within a threshold distance of the center of the ROI. In some examples, the starting pixel is selected as a pixel having a highest likelihood of wildfire ignition within the ROI. For example, the ROI (or a region within which the ROI is located) can be processed through a ML model that predicts likelihood of wildfire ignition for each pixel, which can be used to determine a starting pixel.

Pixel transition probabilities are generated (706). For example, and as described herein, transition probabilities are provided as a prediction output by a ML model (e.g., the pixel transition probability module 202 can execute a ML model that receives the ROI data 220 as input and, for each neighboring pixel of a center pixel, predicts a transition probability). In some examples, the center pixel (starting pixel) has a transition probability of 1.00. Neighboring pixel transition probabilities are generated (708). For example, and as described herein with reference to FIG. 4, the neighboring pixel transition probability module 204 determines transition probabilities for the neighboring pixels by incrementally shifting the frame 300 across the ROI and, for each increment, transition probabilities are determined. the neighboring pixel transition probability module 204 determines transition probabilities using the same ML model as the pixel transition probability module 202. In some examples, the pixel transition probability module 202 and the neighboring pixel transition probability module 204 can be provided as a single module that uses the ML model to predict pixel transition probabilities and neighboring pixel transition probabilities as described herein.

Chained probabilities are determined (710). For example, and as described herein, the chained probability module 206 of the ML system 200 of FIG. 2 can determine the chained probabilities using any appropriate technique. Example techniques described herein include, without limitation, determining chained probabilities by multiplying the transition probabilities along paths from the original ignition point (e.g., the center pixel 302 of FIG. 3) to respective pixels within the distance kernel, aggregating by a union of all of the transition probabilities along a path (e.g., adding up the transition probabilities of each path and subtracting the probability of two paths co-occurring), and stochastically chaining the transition probabilities.

The chained probabilities are adjusted (712). For example, and as described herein, the chained probability adjustment module 208 of the ML system 200 of FIG. 2 adjusts the chained probabilities to account for the likelihood of ignition at the ignition point (i.e., the starting pixel). Ignition-based weighting or feature-based weighting can be used to adjust the chained probabilities, as described herein. The (adjusted) chained probabilities are combined to provide connectivity data (714), and a connectivity map is displayed (716). For example, and as described herein, the adjusted (weighted) chained probability maps are combined (e.g., by the combining module 210 of the ML system 200 of FIG. 2) to produce connectivity data (e.g., the connectivity data 200 of FIG. 2). In some examples, the adjusted chained probability maps can be stacked according to their geolocation and summed to obtain the combined chained probability as connectivity data for each pixel within the ROI. In some examples, combined chained probability values are associated with a graphical treatment (e.g., color, shade) within a set of graphical treatments and are plotted based on their respective geo-locations to provide a connectivity map, such as the connectivity map 100 of FIG. 1.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in some cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Data processing apparatus for implementing machine learning models can also include, for example, special-purpose hardware accelerator units for processing common and compute-intensive parts of machine learning training or production (i.e., inference, workloads).

Machine learning models can be implemented and deployed using a machine learning framework (e.g., a TensorFlow framework, a Microsoft Cognitive Toolkit framework, an Apache Singa framework, an Apache MXNet framework).

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification, or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving, by a wildfire modeling system, region of interest (ROI) data representative of pixels that represent a geographical ROI;
generating, by the wildfire modeling system, transition probabilities for each pixel in the ROI data;
determining, by the wildfire modeling system, chained probabilities along each path in a set of paths within the ROI;
adjusting, by the wildfire modeling system, the chained probabilities based on a likelihood of ignition of a starting pixel represented in the ROI data;
combining, by the wildfire modeling system, the adjusted chained probabilities to provide connectivity data that represents respective likelihood of spread of a wildfire from the starting pixel to each other pixel within the ROI; and
displaying a connectivity map that graphically represents connectivity data of each pixel within the ROI.

2. The method of claim 1, wherein each transition probability is generated by a machine learning (ML) model that receives at least a portion of the ROI data as input and provides transition probabilities for respective pixels represented in the at least a portion of the ROI data as output.

3. The method of claim 2, wherein the ML model is a gradient boosted decision trees model.

4. The method of claim 2, wherein the ML model is trained using training data representative of one or more of data types comprising existing vegetation cover, existing vegetation type, existing vegetation type, digital elevation model, canopy cover, canopy bulk density, population density, land cover type, imperviousness, roads, precipitation, minimum relative humidity, fuel moisture over a configured period, maximum temperature, enhanced vegetation index, normalized difference vegetation index (NDVI), normalized difference water index, mean wind speed, wind speed variance, and wind rose directions.

5. The method of claim 1, wherein the chained probabilities are determined using one of a sum over paths and a union over paths.

6. The method of claim 1, wherein generating the transition probabilities for each pixel in the ROI data comprises:
identifying a starting pixel in the ROI data and assigning a predefined transition probability to the starting pixel;
initiating a current position of a center pixel at the starting pixel;
repeatedly performing, until the transition probabilities of all pixels in the ROI have been determined, operations comprising:
generating transition probabilities of pixels neighboring the center pixel; and
shifting the current position of the center pixel to another position within the ROI.

7. The method of claim 6, wherein generating the transition probabilities for each pixel in the ROI data further comprises:
maintaining a set of cache entries storing transition probabilities that have been previously generated for a set of pixels in the ROI; and
when generating the transition probability for a neighboring pixel, upon determining that the transition probability of the neighboring pixel is stored in one of the cache entries, retrieving the stored transition probability for the neighboring pixel.

8. The method of claim 7, wherein generating the transition probabilities for each pixel in the ROI data further comprises:
determining one or more likely fire paths in the ROI; and
maintaining the transition probabilities of pixels on the likely fire paths in the cache entries.

9. The method of claim 1, wherein determining the chained probabilities comprises:
for each specific path from an ignition point, generating a respective value by multiplying the transition probabilities along the specific path from the ignition point to a pixel within the ROI; and
summing the respective values over all possible paths to the pixel.

10. The method of claim 1, wherein determining the chained probabilities comprises:
summing the transition probabilities of each path and subtracting the probability of two paths co-occurring.

11. The method of claim 1, wherein determining the chained probabilities comprises, for each pixel in the ROI:
for a plurality of iterations, sampling from a uniform distribution, and computing a binary value for the pixel based on a comparison between the sample and the transition probability of the pixel; and
computing a mean of the binary values computed from the plurality of iterations.

12. The method of claim 1, wherein adjusting the chained probabilities comprises:
determining the likelihood of ignition of the starting pixel; and
multiplying the chained probabilities of the pixels in the ROI by the likelihood of ignition of the starting pixel.

13. The method of claim 12, wherein determining the likelihood of ignition of the starting pixel comprises:
predicting the likelihood of ignition of the starting pixel using a machine-learning model.

14. The method of claim 1, wherein adjusting the chained probabilities comprises:
weighting each chained probability with a respective feature value of the corresponding pixel in the ROI.

15. The method of claim 14, wherein the respective feature values of the pixels in the ROI are determined based on one or more of: an NDVI, a landcover type, roads, or whether a corresponding surface is impervious.

16. The method of claim 1, wherein combining the adjusted chained probabilities to provide connectivity data comprises:
aligning chained probability maps according to respective geolocations of the chained probability maps; and
summing the aligned chained probability maps to obtain a combined chained probability maps as the connectivity data.

17. A system comprising:
one or more computers; and
one or more storage devices storing instructions that when executed by the one or more computers, cause the one or more computers to perform the operations comprising:
receiving, by a wildfire modeling system, region of interest (ROI) data representative of pixels that represent a geographical ROI;
generating, by the wildfire modeling system, transition probabilities for each pixel in the ROI data;
determining, by the wildfire modeling system, chained probabilities along each path in a set of paths within the ROI;
adjusting, by the wildfire modeling system, the chained probabilities based on a likelihood of ignition of a starting pixel represented in the ROI data;
combining, by the wildfire modeling system, the adjusted chained probabilities to provide connectivity data that represents respective likelihood of spread of a wildfire from the starting pixel to each other pixel within the ROI; and
displaying a connectivity map that graphically represents connectivity data of each pixel within the ROI.

18. The system of claim 17, wherein each transition probability is generated by a machine learning (ML) model that receives at least a portion of the ROI data as input and provides transition probabilities for respective pixels represented in the at least a portion of the ROI data as output.

19. One or more computer-readable storage media storing instructions that, when executed by one or more computers, cause the one or more computers to perform the operations comprising:
receiving, by a wildfire modeling system, region of interest (ROI) data representative of pixels that represent a geographical ROI;
generating, by the wildfire modeling system, transition probabilities for each pixel in the ROI data;
determining, by the wildfire modeling system, chained probabilities along each path in a set of paths within the ROI;
adjusting, by the wildfire modeling system, the chained probabilities based on a likelihood of ignition of a starting pixel represented in the ROI data;
combining, by the wildfire modeling system, the adjusted chained probabilities to provide connectivity data that represents respective likelihood of spread of a wildfire from the starting pixel to each other pixel within the ROI; and
displaying a connectivity map that graphically represents connectivity data of each pixel within the ROI.

20. The one or more computer-readable storage media of claim 19, wherein generating the transition probabilities for each pixel in the ROI data comprises:
identifying a starting pixel in the ROI data and assigning a predefined transition probability to the starting pixel;
initiating a current position of a center pixel at the starting pixel;
repeatedly performing, until the transition probabilities of all pixels in the ROI have been determined, operations comprising:
generating transition probabilities of pixels neighboring the center pixel; and
shifting the current position of the center pixel to another position within the ROI.
